(19) United States
(12) Patent Application Publication
(10) Pub. No.: US 2006/0002269 A1
(43) Pub. Date: Jan. 5, 2006

(54) Information storage device capable of impairing optical integrity of an optical storage medium thereof

(76) Inventors: Eric Bourget, Laval (CA); Robert Prust, L'Orignal (CA)

Correspondence Address: ERIC BOURGET, 2530 DU COLIBRI, LAVAL, QC, H7L 5T5, CA

(21) Appl. No.: 10/950,758

(22) Filed: Sep. 28, 2004

Related U.S. Application Data
(60) Provisional application No. 60/583,627, filed on Jun. 30, 2004.

(51) Int. Cl. G11B 7/26

(52) U.S. Cl. 369/59.1; 369/272.1

(57) ABSTRACT

An information storage device comprising an optical storage medium and an impairment unit coupled to the optical storage medium and capable of being activated electrically. The impairment unit is operative to impair optical integrity of a portion of the optical storage medium when activated. The information storage device also comprises an activation unit electrically coupled to the impairment unit and adapted to conditionally activate the impairment unit. A method of manufacturing such an information storage device and a method of providing such an information storage device are also provided.

### CROSS-REFERENCE TO RELATED APPLICATION

The present application claims the benefit under 35 U.S.C. 119(e) of U.S. provisional application No. 60/583,627 filed on Jun. 30, 2004.

### FIELD OF THE INVENTION

The present invention relates to information storage media and, more particularly, to an information storage device capable of impairing the optical integrity of an optical storage medium of the information storage device.

### BACKGROUND OF THE INVENTION

An information storage medium such as a digital versatile (or video) disc (DVD) or a compact disc (CD) is capable of storing, in digital form, a relatively large amount of information that can be used in various applications. For example, information storage media such as DVDs and CDs are frequently used to store movies, video games, music, software programs and other multimedia content as well as various other types of information.

In some cases, it is desirable to limit usage of the information stored in an information storage medium. One such case arises in the context of rental of movies on DVDs. Typically, a customer rents a DVD storing a movie from a video rental store by paying a fraction of the purchase price of the DVD in exchange for a limited period of time for viewing the movie. Once the limited period of time for viewing the movie expires, the customer must return the DVD to the video rental store in order to avoid having to pay a late-return fee.

Another case where limited usage of the information stored in an information storage medium is desirable arises in the context of software licensing and installation. Typically, a software provider provides to a customer an information storage medium storing software therein as well as a license permitting a limited usage of the software. The license can be defined by, for instance, a certain permitted number of installations of the software. Once the information storage medium storing the software is in the possession of the customer, the software provider must assume that the customer will respect the license or rely on random verifications of the customer's equipment in order to ensure that the license is respected.

Of course, there are various other cases where limited usage of the information stored in an information storage medium is desirable.

Some existing information storage media have been manufactured using materials reactive to certain external conditions in order to limit usage of information stored in the storage media. However, these existing information storage media suffer from multiple drawbacks. One such drawback is that the limit on usage of information stored in the information storage media can only be configured during manufacturing of the storage media.

Accordingly, there is a need in the industry for improvements in information storage devices capable of self-limiting, at least to some extent, usage of information stored therein.

### SUMMARY OF THE INVENTION

In accordance with a first broad aspect, the invention provides an information storage device. The information storage device comprises an optical storage medium and an impairment unit coupled to the optical storage medium and capable of being activated electrically. The impairment unit is operative to impair optical integrity of a portion of the optical storage medium when activated. The information storage device also comprises an activation unit electrically coupled to the impairment unit and adapted to conditionally activate the impairment unit.

In accordance with a second broad aspect, the invention provides an information storage device. The information storage device comprises an optical storage medium and impairment means coupled to the optical storage medium and capable of being activated electrically, for impairing optical integrity of a portion of the optical storage medium when activated. The information storage device also comprises activation means electrically coupled to the impairment means for conditionally activating the impairment means.

In accordance with a third broad aspect, the invention provides a method of manufacturing an information storage device. The method comprises providing an optical storage medium and coupling an impairment unit to the optical storage medium. The impairment unit is capable of being activated electrically and operative to impair optical integrity of a portion of the optical storage medium when activated. The method also comprises electrically coupling an activation unit to the impairment unit, the activation unit being adapted to conditionally activate the impairment unit.

In accordance with a fourth broad aspect, the invention provides a method of providing an information storage device. The method comprises providing an information storage device including an optical storage medium and an impairment unit coupled to the optical storage medium and capable of being activated electrically. The impairment unit is operative to impair optical integrity of a portion of the optical storage medium when activated. The information storage device also comprises a programmable activation unit electrically coupled to the impairment unit and adapted to activate the impairment unit upon satisfaction of a condition. The method also comprises receiving an indication of a limit on usage of the optical storage medium. The method further comprises setting the condition of the activation unit to reflect the limit on usage of the optical storage medium.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of specific embodiments of the present invention is provided herein below, by way of example only, with reference to the accompanying drawings, in which:

FIG. 1 is a diagrammatic plan view of an information storage device in accordance with a specific example of implementation of the present invention;

FIG. 2 is a diagrammatic partial cross-sectional elevation view of the information storage device shown in FIG. 1, taken along line 2-2 in FIG. 1;

FIG. 3 is a block diagram of an example of implementation of an activation unit of the information storage device shown in FIG. 1;

FIG. 4 depicts an example of a configuration of an impairment unit of the information storage device in accordance with an example of implementation of the present invention; and

FIG. 5 is a block diagram of an example of implementation of a programming module for programming the activation unit of the information storage device shown in FIG. 3. In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

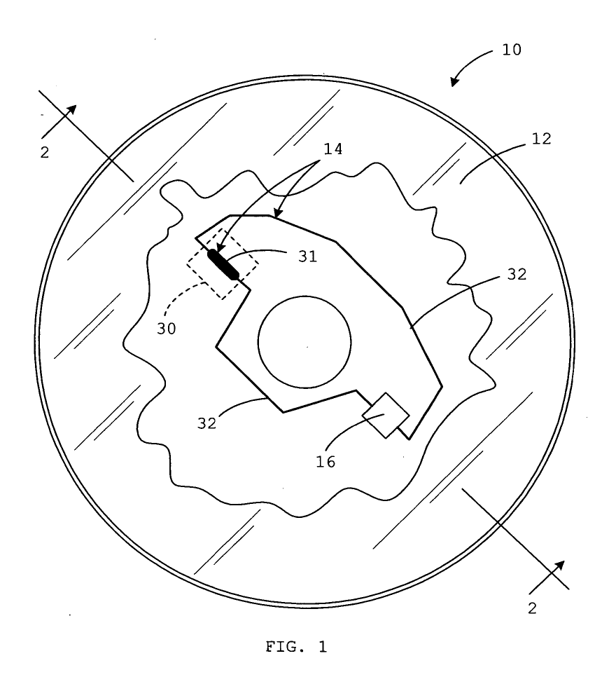

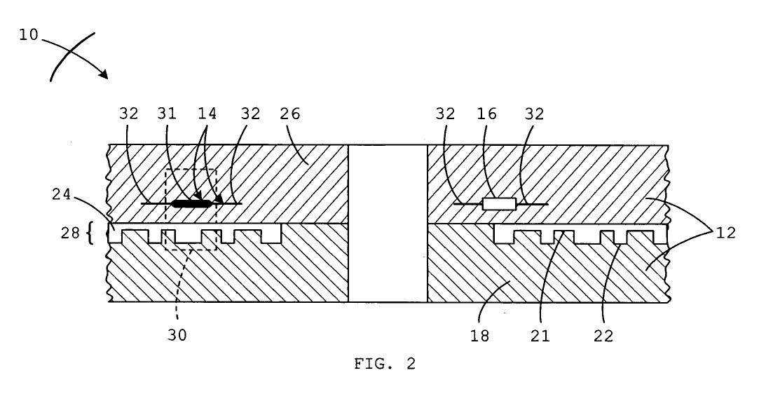

FIGS. 1 and 2 show an information storage device 10 in accordance with a non-limiting example of implementation of the invention. The information storage device 10 comprises a storage medium 12, an impairment unit 14, and an activation unit 16 electrically coupled to the impairment unit 14. As described in further detail below, the function of the impairment unit 14, when activated, is to impair the optical integrity of at least part of the storage medium 12, thus preventing, or at least impeding, further usage of at least that part of the storage medium 12.

The activation unit 16 achieves electrical activation of the impairment unit 14, provided that a so-called “trigger condition” is satisfied. As further detailed below, this trigger condition can be deemed to be satisfied when, say, a count of a number of readings of the storage medium 12 by a reading unit has reached a certain value, a measurement of time elapsed from a certain point in time has reached a particular value, a function of both, or when any other conceivable parameter characterizing usage of the storage medium 12 has reached a given value. Advantageously, the trigger condition can be programmed into the information storage device 10 at any time, including before, during or after manufacture of the information storage device 10.

With continued reference to FIGS. 1 and 2, the storage medium 12 is a medium storing digital information in an optical manner. The storage medium 12 is optically readable by a reading unit (not shown) external to the information storage device 10. In the specific example of implementation of FIGS. 1 and 2, the storage medium 12 includes a first substrate 18 defining a plurality of pits 21 and lands 22 each of which define a channel bit, that after modulation by the optical reader, represent digital information.

Also provided is a reflective layer 24 covering the channel bits (pits 21 and lands 22) and a second substrate 26 bonded to the reflective layer 24 in order to interconnect the first and second substrates 18 and 26. The first and second substrates 18 and 26 are made of polycarbonate, while the reflective layer 24 is a metallic layer such as an aluminum layer. It will be appreciated that various other materials can be used in making the storage medium 12 without departing from the scope of the invention.

The channel bits (pits 21 and lands 22) are covered with the reflective layer 24 that define the information layer 28 of the storage medium 12, wherein each one of the channel bits represents a digital value, for instance, a digital “1” is a land 22, and a pit 21 represents a second digital value “0”. The channel bits (pits 21 and lands 22) are arranged along a track, which is typically a continuous spiral, and creates the information layer 28. When the information storage device 10 is “pre-recorded”, the channel bits (pits 21 and lands 22) are arranged in a particular combination that conveys digital information such as a digitally encoded image, a software program or sound. It should be expressly understood that the present invention applies to information storage devices 10 having both blank and non-blank information layers 28.

In order to read or access the digital information stored in the storage medium 12, a reading unit (not shown) is positioned below the information storage device 10 and has a laser emitter that emits a laser beam having a predetermined focusing depth and that is movable relative to the storage medium 12. The laser beam penetrates through the first substrate 18 and reaches the reflective layer 24 where it is reflected back towards the reading unit. As the laser emitter moves relative to the storage medium 12 in order to follow the information track, the laser beam reflects differently on the pits 21 than on the lands 22. The reading unit includes an opto-electronic unit that detects changes in reflectivity of the reflected laser beam and electronics that interpret the changes in reflectivity in order to determine the digital values, or bits, being read.

The reading unit also includes a processing module that receives and processes the bits read by the reading unit in order to make use of the information stored in the storage medium 12. In some cases, the information stored in the storage medium 12 is encoded in a certain format. In such cases, the processing effected by the processing module includes a decoding of the received bits.

It will be appreciated that the storage medium 12 described above can be a compact disc (CD) or a single information layer digital versatile (or video) disc (DVD), also known as a DVD-5. The DVD and CD formats are well known to those skilled in the art and, as such, the configuration and distribution of the pits 21 and lands 22 defining the information layer 28 will not be described in any further detail. Furthermore, although the storage medium 12 of the specific example of implementation shown in FIGS. 1 and 2 has a single information layer 28, it will be appreciated that the storage medium 12 can include multiple information layers without departing from the scope of the invention. For example, the storage medium 12 can include multiple information layers and can be configured as a DVD-9, DVD-10, DVD-18, HD-DVD, BlueRay, Hybrid SACD, CD or DVD, or according to any other configuration. In addition, it is reiterated that the storage medium 12 can be a blank medium that does not convey any digital information. For instance, the storage medium 12 can be a blank writable CD or a blank writable DVD and remain within the scope of the present invention.

With continued reference to FIGS. 1 and 2, the impairment unit 14 is coupled to the storage medium 12. In the specific example of implementation shown, the impairment unit 14 is embedded in the second substrate 26 proximate to the information layer 28 of the first substrate 18.

The impairment unit 14 is capable of being activated by an electrical signal from the activation unit 16. When it is activated, the impairment unit 14 is operative to impair the optical integrity of a portion 30 of the storage medium 12. In the particular example of implementation of FIGS. 1 and 2, the impairment unit 14, when activated by the activation unit 16, is operative to generate heat for damaging the portion 30 of the storage medium 12.

The heat generated by the impairment unit 14 when activated is sufficient to melt at least partially the portion 30. More specifically, the heat generated by the impairment unit 14 when activated is sufficient to melt at least partially the pits 21 and lands 22 of the information layer 28 of the portion 30. In the specific embodiment shown, the impairment unit 14 includes a conductive element 32 responsive to flow of an electric current to a filament 31 therein to generate heat for damaging the portion 30 of the storage medium 12. The filament 31 can be implemented, for instance, as tungsten, nickel chromium or other filament or wire. As described in further detail below, the activation unit 16 activates the impairment unit 14 by causing flow of an electric current in the conductive element 32 and filament 31.

Generally speaking, and regardless of whether the impairment unit 14 functions to generate heat or uses other means, the impairment unit 14 will be designed to inflict sufficient damage to the portion 30 so as to corrupt the digital information originally stored by the portion 30 prior to being damaged. For instance, the portion 30 will be sufficiently distorted or warped such that, overall, the pits 21 and lands 22 of the portion 30 tend to acquire a configuration lying between the configuration of a pit 21 and a land 22, i.e. the degree of distinctiveness between the pit 21 and land 22 is reduced. As a result, an attempt by a reading unit to read the correct digital information originally represented by the portion 30 of the storage medium 12, prior to being damaged, leads to an incorrect reading.

While the above description and FIGS. 1 and 2 illustrate one possible example of implementation for the impairment unit 14, it is to be understood that various other examples of implementation for the impairment unit 14 are possible without departing from the scope of the invention.

In the particular embodiment shown, the portion 30 of the storage medium 12 stores information that is required to decode encoded digital information stored in other portions of the storage medium 12. The information stored in portion 30 is used by the processing module of a reading unit (not shown) in order to decode encoded digital information stored in the storage medium 12. For example, some of the information stored in the portion 30 can represent an encryption key code necessary for decoding encoded digital information stored in the storage medium 12. In a case where the storage medium 12 is a DVD, the encryption key code is normally located on a lead-in area of the DVD. Hence, once the impairment unit 14 has been activated in order to damage the portion 30, the processing module of the reading unit can, no longer correctly decode the encoded digital information stored in undamaged portions of the storage medium 12, although still intact. As a result, the information stored in the storage medium 12 can no longer be used in any useful way or for its intended purpose.

Thus, advantageously, when the information stored in the storage medium 12 is encoded, the impairment unit 14 can be configured so as to damage only a relatively small portion of the storage medium 12 that contributes to decoding of encoded digital information stored in the medium 12.

However, even if the storage medium 12 stores encoded digital information, it is to be understood that the impairment unit 14 can also be configured so as to damage one or more portions of the storage medium 12 which do not contribute to decoding of the encoded digital information.

When the digital information stored in the storage medium 12 is not encoded, the impairment unit 14 can be configured so as to damage one or more portions of the storage medium 12 so as to lead to incorrect readings of the correct digital information originally stored in these one or more portions, prior to being damaged. An important embodiment is, the portion 30 of the storage medium 12 stores partial information that is compiled or un-compiled computer program data. That is, the information stored in portion 30 is part of the executable code used by a computer to execute some function. Hence, once the impairment unit 14 has been activated in order to damage the executable code stored in portion 30, the program as a whole can no longer be correctly decoded by the Central Processing Unit. As a result, the program information stored in the storage medium 12 can no longer be used in any useful way or for its intended purpose.

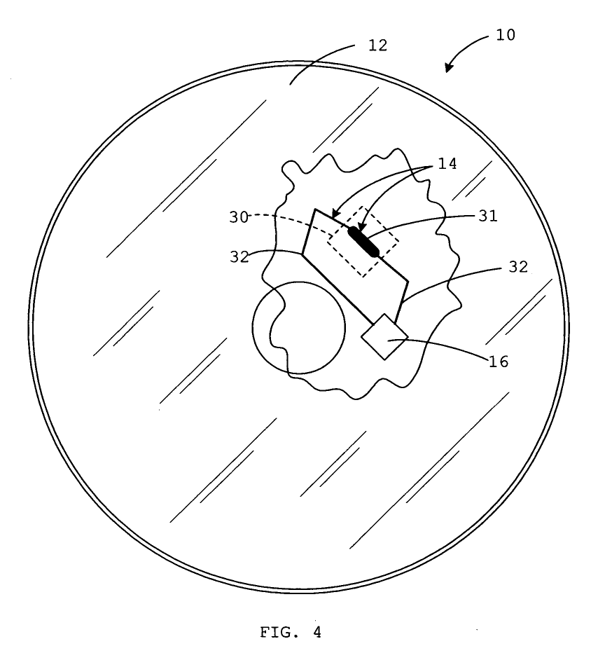

FIG. 4 depicts an example of implementation in which the impairment unit 14, when activated, is operative to impair the optical integrity of a portion of the storage medium 12 that has a different location, size or configuration from software program to software program. Of course, it is to be understood that the impairment unit 14 can be designed such that it can impair the optical integrity of one or more portions of the storage medium 12 that have various other configurations and sizes, without leaving the scope of the invention.

With continued reference to FIGS. 1 and 2, the activation unit 16 is electrically coupled to the impairment unit 14 and is adapted to conditionally activate the impairment unit 14. Conditional activation of the impairment unit 14 by the activation unit 16 is based on a determination by the activation unit 16 of whether or not a trigger condition is satisfied. When the activation unit 16 determines that the trigger condition is satisfied, the activation unit 16 activates the impairment unit 14 so that the latter impairs the optical integrity of the portion 30 of the storage medium 12 in order to prevent or at least impede further usage of the information stored in the storage medium 12.

The determination by the activation unit 16 as to whether the trigger condition is satisfied depends on the manner in which the trigger condition is defined. As an example, the activation unit 16 can determine that determining that a count of a number of readings of the storage medium 12 by a reading unit has reached a threshold value satisfies the trigger condition. For instance, the activation unit 16 can determine that the trigger condition is satisfied by determining that three (3) readings, ten (10) readings, or any other number of readings of the storage medium 12 by a reading unit have occurred. Of course, it is possible to specify certain criteria defining what constitutes a reading of the storage medium 12 by a reading unit and which are monitored by the activation unit 16 in determining whether or not a reading of the storage medium 12 actually represents a reading for the purposes of the count of a number of readings of the storage medium 12 by a reading unit. For instance, if a first reading of the storage medium 12 is stopped and a second reading of the storage medium 12 is initiated within a certain amount of time, say, thirty (30) minutes, from stopping the first reading, then the first reading can effectively be ignored by the activation unit 16 for the purposes of the count of a number of readings of the storage medium 12 by a reading unit.

As another example, the activation unit 16 can determine that the trigger condition is satisfied by determining that a measurement of time elapsed from a certain point in time has reached a threshold value. The certain point in time can be a current point in time or a later point in time. For instance, the activation unit 16 can determine that the trigger condition is satisfied by determining that forty-eight (48) hours, ten (10) days, three (3) years, or any other period of time has passed since a certain point in time.

As yet another example, the activation unit 16 can determine whether the trigger condition is satisfied based on some function of a count of a number of readings of the storage medium 12 by a reading unit and a measurement of time elapsed from a certain point in time. For instance, the activation unit 16 can determine that the trigger condition is satisfied by determining either that four (4) readings of the storage medium 12 by a reading unit have occurred or that two (2) years since a certain point in time or since the first reading of the storage medium 12 have passed.

While the previous paragraphs presented some possible examples of parameters that can be used to define the trigger condition, it is to be understood that various other parameters can be used to define the trigger condition without departing from the scope of the invention. Regardless of the manner in which the trigger condition is defined, once the activation unit 16 determines that it is satisfied, the activation unit 16 activates the impairment unit 14, which in turn impairs the optical integrity of the portion 30 of the storage medium 12 so as to prevent or at least impede further usage of the storage medium 12.

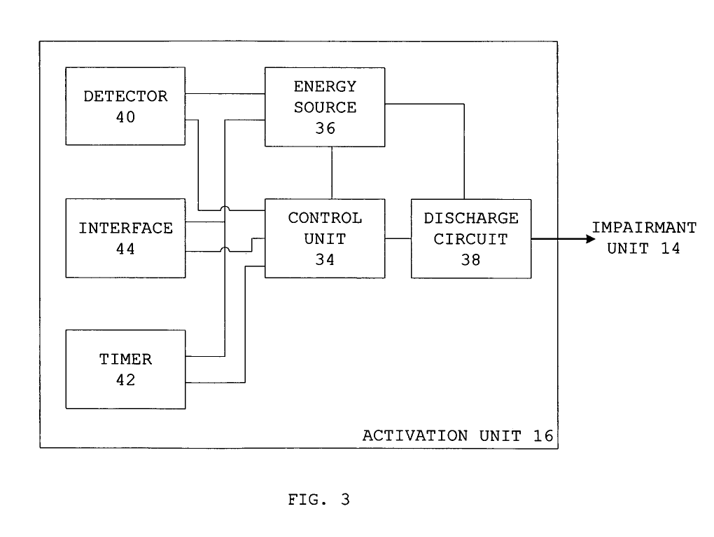

FIG. 3 is a block diagram of a non-limiting example of implementation of the activation unit 16. In this particular embodiment, the activation unit 16 comprises a control unit 34 coupled to an energy source 36, a discharge circuit 38, a detector 40, a timer 42, and an interface 44.

The control unit 34 is adapted to determine whether the trigger condition is satisfied and, based on this determination, to activate the impairment unit 14. The control unit 34 is programmable such as to allow the trigger condition to be programmed into the control unit 34.

In the particular example of implementation shown in FIG. 3, the interface 44 is adapted to receive a programming signal from a programming module (not shown) external to the information storage device 10 in order to program the trigger condition into the control unit 34. Advantageously, the interface 44 can be a wireless interface and can be implemented using a RF receiver or any other wireless receiver or transceiver. By being wireless, the interface 44 allows programming of the control unit 34 at any time, even after manufacturing of the information storage device 10. Optionally, the interface 44 can also provide the ability to query the trigger condition programmed into the control unit 34 using the programming module external to the information storage device 10. While providing numerous advantages, it is to be understood that, in other examples of implementation, the interface 44 can be omitted in which case the trigger condition can be programmed into the control unit 34 using the detector 40 or any other known technique, before, during, or after the manufacturing of the information storage device 10. The control unit 34 is configured to detect a programming condition from the detector 40 by receiving a preset number of pulses in a set time. Once the control unit 34 has been set in the programming mode, another series of pulses received by the detector 40 will program the number of plays and/or the time from a certain point in time since the first reading of the storage medium 12 before signaling the discharge circuit 38 to trigger the impairment unit 14.

The control unit 34 interacts with the detector 40 and the timer 42 in order to determine whether the trigger condition is satisfied. The detector 40 is responsive to incidence of a laser beam by a reading unit. The detector 40 can be implemented, for instance, using a photodiode. The control unit 34 is adapted to receive the signal generated by the detector 40 and determines that a reading unit is reading the storage medium 12 when the number of pulse equals a preset number over an amount of time. The control unit 34 maintains a count of a number of readings of the storage medium 12 by a reading unit. For its part, the timer 42 is adapted to measure time from a certain point in time and to generate a signal indicative of a measurement of time elapsed from that certain point in time. The timer 42 can be implemented using any known clock or timer circuit. The control unit 34 is adapted to receive the signal generated by the timer 42.

Thus, based on the signals received from the detector 40 and the timer 42, the control unit 34 is capable of determining whether the trigger condition is satisfied. For instance, depending on the manner in which the trigger condition is defined, the control unit 34 is adapted to determine whether the count of a number of readings of the storage medium 12 by a reading unit has reached a certain value, and/or determine whether the measurement of time elapsed from a certain point in time has reached a particular value.

If the control unit 34 determines that the trigger condition is satisfied, the control unit 34 activates the impairment unit 14 such that the latter impairs the optical integrity of the portion 30 of the storage medium 12 so as to prevent or at least impede further usage of the storage medium 12. In the particular embodiment shown, the control unit 34 activates the impairment unit 14 by enabling the discharge circuit 38 to use energy from the energy source 36 to produce flow of an electric current in the conductive element 32 of the impairment unit 14. As described previously, the passage of an electric current in the conductive element 32 and filament 31, enables the filament 31 to generate heat that damages the portion 30 of the storage medium 12.

The energy source 36 can be implemented using an electrochemical generator such as a thin-film lithium ion or zinc manganese dioxide electrochemical generator. In the particular example of implementation shown, the energy source 36, in addition to providing the energy required for impairing the optical integrity of the portion 30 of the storage medium 12, also provides energy for operating the other components of the activation unit 16. In an alternative example of implementation, the energy source 36 can include a first energy source dedicated to providing the energy required to impair the optical integrity of the portion 30 of the storage medium 12 and a second, separate energy source dedicated to providing energy for operating the other components of the activation unit 16.

The control unit 34, the timer 42, the interface 44 and the detector 40 can be implemented, for example, as an integrated circuit such as an Application Specific Integrated Circuit (ASIC), a multi-chip module (MCM), or a microprocessor. The various components of the activation unit 16 and optionally the impairment unit 14 can be mounted on a printed circuit board (PCB) or flexible PCB which can be embedded in the storage medium 12 during manufacturing of the information storage device 10. Advantageously, the PCB or flexible PCB, and in particular the energy source 36 mounted thereon, can be configured so as to distribute the weight of the activation unit 16 and the impairment unit 14 evenly within the storage medium 12 which is a requirement in optical readers.

It will thus be appreciated that the various components of the information storage device 10 interact so as to prevent unlimited and unimpeded usage of the storage medium 12. Specifically, the trigger condition can be programmed into the control unit 34 during manufacturing of the information storage device 10 or at any time thereafter via the interface 44 or detector 40. As the storage medium 12 is read by a reading unit, the detector 40 ability to detect the optical readers laser light enables the control unit 34 to keep track of how many times the storage medium 12 has been read. At the same time, the timer 42 enables the control unit 34 to keep track of the passage of time. When the control unit 34 determines that the trigger condition is satisfied, the control unit 34 activates the impairment unit 14 in order to impair the optical integrity of the portion 30 of the storage medium 12, thereby corrupting the information represented by the portion 30. In the particular embodiment shown, activation of the impairment unit 14 is effected by the control unit 34 enabling the discharge circuit 38 to use energy from the energy source 36 to produce flow of an electric current in the conductive element 32 and filament 31 of the impairment unit 14. The heat generated by the passage of the electric current damages the portion 30 of the storage medium 12 so as to prevent or at least impede further usage of the storage medium 12.

It will also be appreciated that FIGS. 1 to 3 illustrate one particular example of implementation of the information storage device 10 and that various modifications to, or other examples of implementation of, the information storage device 10 are possible without departing from the scope of the invention. For example, in a specific example of implementation, the impairment unit 14 is a first impairment unit 14 and the information storage device 10 includes a second impairment unit (not shown) electrically coupled to the activation unit 16 and that, when activated by the activation unit 16, is operative to impair the optical integrity of the portion 30 or an other portion of the storage medium 12. Furthermore, the activation unit 16 is adapted to detect a defective operation of the first impairment unit 14, the second impairment unit, and the activation unit 16 itself. For instance, the activation unit 16 can be adapted to detect open electrical connections inside itself and between itself and the first and second impairment units and to determine that a given component is defective when an open electrical connection is detected. Such open electrical connections can result, for example, from the information storage device 10 being tampered with. Also, the activation unit 16 can determine that it is itself defective when an energy level in the energy source 36 falls below a preset level. In response to detection of a defective operation of a given one of the first impairment unit 14, the second impairment unit, and the activation unit 16 itself, the activation unit 16 determines that the trigger condition is satisfied and activates one of the first or second impairment units that is not the given one of the components for which a defective operation has been detected.

The information storage device 10 can be used in various applications where limited usage of a storage medium 12 is desired. Examples of application of the information storage device 10 will now be described.

In a first example of application, the information storage device 10 can be used in the context of DVD or CD rentals. Typically, a provider of DVDs or CDs rents a DVD or CD to a renter that desires to access the information stored in the DVD or CD without purchasing or owning the DVD or CD. For illustrative purposes, it can be assumed that the provider is a retail store, such as a video rental store, involved in offering for viewing movies or other audio/video content on DVDs. For each movie or other audio/video content that the retail store offers, the retail store stocks a number of information storage devices 10 each configured as the information storage device 10 and storing the movie or other audio/video content in the storage medium 12.

A customer desiring to view a particular movie or other audio/video content offered by the retail store selects an information storage device 10 storing the particular movie or other audio/video content. In order to complete the transaction with the retail store, the customer provides to an employee of the retail store an indication of a limit on viewing of the movie or other audio/video content that the customer desires to have. For example, the customer can indicate to the employee that he or she desires to be able to view the movie or other audio/video content for a period of two (2) days, three (3) times, five (5) times in the upcoming three (3) months, for a period of one (1) week following a first viewing, or according to any other conceivable limit on viewing that the customer may desire.

Based on the customer's indication, the employee programs the limit on viewing of the movie or other audio/video content into the activation unit 16 of the information storage device 10. To that end, the employee can use a programming module adapted to program the limit on viewing of the movie or other audio/video content into the control unit 34 of the activation unit 16.

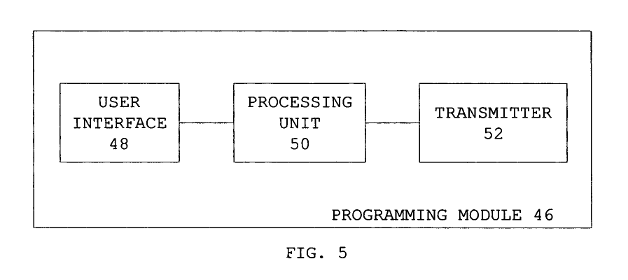

FIG. 5 is a block diagram of an example of implementation of a programming module 46 for programming the activation unit 16 of the information storage device 10. In this particular embodiment, the programming module 46 includes a user interface 48, a processing unit 50 coupled to the user interface 48, and a transmitter 52 coupled to the processing unit 50. The user interface 48 is adapted to allow the employee to enter information indicative of the desired limit on viewing of the movie or other audio/video content. The processing unit 50 is adapted to receive from the user interface 48 the information indicative of the desired limit on viewing of the movie or other audio/video content and to generate a programming signal indicative thereof. The transmitter 52 is adapted to receive the programming signal from the processing unit 50 and to transmit it to the interface 44, or detector 40 of the activation unit 16. The user interface 48 and the processing unit 50 can be implemented using a computer and the transmitter 52 can be implemented using a programming wand coupled to the computer.

Once programming of the activation unit 16 is completed, the customer completes the transaction by paying for the information storage device 10 storing the selected movie or other audio/video content. The amount charged for the information storage device 10 can be made dependent on the desired limit on viewing of the movie or other audio/video content that has been programmed into the information storage device 10. The customer can then leave the rental store and enjoy viewing of the movie or other audio/video content stored in the information storage device 10, subject to the limit on viewing programmed therein. Once the limit on viewing of the movie or other audio/video content is reached, the trigger condition is satisfied and the activation unit 16 activates the impairment unit 14 so as to impair the optical integrity of the portion 30 of the storage medium 12 in order to prevent, or at least considerably impede, further viewing of the movie or other audio/video content stored in the storage medium 12.

Advantageously, the ability to program the information storage device 10 provides flexibility to the customer in terms of selecting a limit on viewing of the movie or other audio/video content that suits the customer's needs. Another clear advantage is that the customer does not need to return the information storage device 10 to the retail store. That is, once the selected limit on viewing of the movie or other audio/video content is reached, the activation unit 16 and the impairment unit 14 will interact so as to prevent further viewing of the movie or other audio/video content stored in the storage medium 12. In other words, while the consumer can still retain possession of the information storage device 10, the damage inflicted to the storage medium 12 by the impairment unit 14 is such that the storage medium 12 can no longer be used for its intended purpose, i.e. allowing unimpeded viewing of the movie or other audio/video content stored therein.

From the perspective of the retail store, the ability to program the information storage device 10 enables an offering of various limits on viewing of the movie or other audio/video content stored in the information storage device 10 in order to suit the needs of various customers. Furthermore, the fact that customers need not return the information storage devices 10 to the retail store tends to reduce operating costs incurred by the retail store. For instance, no labor costs are incurred for monitoring late-returns and enforcing late-return fee penalties as well as for sorting and replacing returned information storage media in the retail store.

While the above example of application related to an information storage device 10 storing a movie or other audio/video content, it will be appreciated that the above example is also applicable to an information storage device 10 storing music, a video game, computer program or any other information content.

In a second example of application, the information storage device 10 can be used in the context of software licensing and installation. Typically, a software provider provides to a customer an information storage device 10 storing software therein as well as a license permitting a limited usage of the software. For instance, the license can permit a certain number of installations of the software, a certain number of simultaneous users of the software, and/or a certain period of time for installing and/or using the software. The certain number of installations can indicate that the customer can install the software a certain number of times or on a certain number of computers.

In this context, the software provider stocks a number of information storage devices 10 each configured as the information storage device 10 and storing the software in the storage medium 12. When a customer desires to acquire the software, the software provider obtains from the customer an indication of a limit on installation of the software that the customer desires to have. For example, the customer can indicate to the software provider that he or she desires to be able to install the software ten (10) times, or on fifty (50) computers, only during the following month, or according to any other conceivable limit on installation of the software that the customer may desire.

Based on the customer's indication, the software provider provides an information storage device 10 storing the software therein and programs the limit on installation of the software into the activation unit 16 of the information storage device 10. To that end, the software provider can use a programming module adapted to program the limit on installation of the software into the control unit 34 of the activation unit 16. The programming module can be implemented as the programming module 46 described previously in connection with FIG. 5.

Once programming of the activation unit 16 is completed, the customer completes the transaction by paying for the information storage device 10 storing the software. The amount charged for the information storage device 10 can be made dependent on the desired limit on installation of the software that has been programmed into the information storage device 10. The customer can then proceed to install on one or more computers the software stored in the information storage device 10, subject to the limit on installation programmed therein. Once the limit on installation is reached, the trigger condition is satisfied and the activation unit 16 activates the impairment unit 14 so as to impair the optical integrity of the portion 30 of the storage medium 12 in order to prevent, or at least considerably impede, further installation of the software stored in the storage medium 12.

Advantageously, the ability to program the information storage device 10 provides flexibility to the customer in terms of selecting a limit on installation of the software that suits the customer's needs. Conversely, from the perspective of the software provider, the ability to program the information storage device 10 enables an offering of various limits on installation of the software in order to suit the needs of various customers. Furthermore, the software provider is better ensured that the software stored in the information storage device 10 will be installed only in accordance with the limit on installation programmed therein. That is, once the selected limit on installation of the software is reached, the activation unit 16 and the impairment unit 14 will interact so as to prevent further installation of the software stored in the storage medium 12. In other words, while the consumer can still retain possession of the information storage device 10, the damage inflicted to the storage medium 12 by the impairment unit 14 is such that the storage medium 12 can no longer be used for its intended purpose, i.e. allowing installation on a computer of the software stored therein. This at least partially alleviates operating costs of the software provider associated with monitoring whether the customer installs the software stored in the information storage device 10 in an unauthorized manner.

It will be appreciated that the two examples of application of the information storage device 10 presented above represent only two possible applications and that a myriad of other possible applications of the information storage device 10 can be envisaged without departing from the scope of the invention.

Although various embodiments have been illustrated, this was for the purpose of describing, but not limiting, the invention. Various modifications will become apparent to those skilled in the art and are within the scope of the present invention, which is defined more particularly by the attached claims.

1. An information storage device comprising:
an optical storage medium;
an impairment unit coupled to said optical storage medium and capable of being activated electrically, said impairment unit being operative to impair optical integrity of a portion of said optical storage medium when activated; and
an activation unit electrically coupled to said impairment unit and adapted to conditionally activate said impairment unit.

2. An information storage device as defined in claim 1, said optical storage medium storing digital information.

3. An information storage device as defined in claim 1, wherein said impairment unit being operative to impair optical integrity of a portion of said optical storage medium comprises said impairment unit being operative to generate heat for damaging said portion of said optical storage medium.

4. An information storage device as defined in claim 3, wherein the heat generated by said impairment unit is sufficient to warp at least partially said portion of said optical storage medium.

5. An information storage device as defined in claim 1, said impairment unit including a conductive element and metallic filament that generates heat for damaging said portion of said optical storage medium when a current is passed through said metallic filament.

6. An information storage device as defined in claim 5, wherein said metallic filament comprises nickel chromium.

7. An information storage device as defined in claim 1, wherein said portion of said optical storage medium stores digital information required for decoding encoded digital information stored in an other portion of said optical storage medium.

8. An information storage device as defined in claim 1, wherein said portion of said optical storage medium stores an encryption key code.

9. An information storage device as defined in claim 1, wherein said portion of said optical storage medium stores an executable computer program.

10. An information storage device as defined in claim 1, wherein said activation unit being adapted to conditionally activate said impairment unit comprises said activation unit being adapted to:
determine whether a trigger condition is satisfied; and
responsive to said trigger condition being satisfied, activate said impairment unit.

11. An information storage device as defined in claim 10, wherein said trigger condition is programmable.

12. An information storage device as defined in claim 11, said activation unit including an interface enabling said trigger condition to be programmable from outside the information storage device.

13. An information storage device as defined in claim 12, wherein said interface is a wireless interface.

14. An information storage device as defined in claim 12, wherein said interface is a photo-diode interface.

15. An information storage device as defined in claim 10, wherein said activation unit is adapted to count a number of readings of said optical storage medium by a reading unit, said activation unit being adapted to determine whether said trigger condition is satisfied comprising determining whether a count of a number of readings of said optical storage medium by a reading unit has reached a threshold value.

16. An information storage device as defined in claim 15, said activation unit comprising:
a detector responsive to incidence of a laser beam on said detector to generate a signal indicative of a reading of said optical storage medium by a reading unit;
a control unit coupled to said detector, said control unit being adapted to:
receive said signal indicative of a reading of said optical storage medium by a reading unit;
maintain a count of a number of readings of said optical storage medium by a reading unit; and
determine whether said count of a number of readings of said optical storage medium by a reading unit has reached said threshold value.

17. An information storage device as defined in claim 16, wherein said detector comprises a photodiode.

18. An information storage device as defined in claim 10, wherein said activation unit is adapted to measure time elapsed from a certain point in time, said activation unit being adapted to determine whether said trigger condition is satisfied determining whether a measurement of time elapsed from a certain point in time has reached a threshold value.

19. An information storage device as defined in claim 18, said activation unit comprising:
a timer adapted to measure time from a certain point in time and to generate a signal indicative of a measurement of time elapsed from a certain point in time; and
a control unit coupled to said timer, said control unit being adapted to:
receive said signal indicative of a measurement of time elapsed from a certain point in time; and
determine whether said measurement of time elapsed from a certain point in time has reached said threshold value.

20. An information storage device as defined in claim 10, wherein said activation unit is adapted to:
count a number of readings of said optical storage medium by a reading unit; and
measure time elapsed from a certain point in time;
said activation unit being adapted to determine whether said trigger condition is satisfied determining whether at least one of:
a count of a number of readings of said optical storage medium by a reading unit has reached a first threshold value; and/or
a measurement of time elapsed from a certain point in time has reached a second threshold value.

21. An information storage device as defined in claim 20, said activation unit comprising:
a detector responsive to incidence of a laser beam on said detector to generate a signal indicative of a reading of said optical storage medium by a reading unit;
a timer adapted to measure time from a certain point in time and to generate a signal indicative of a measurement of time elapsed from a certain point in time; and
a control unit coupled to said detector and to said timer, said control unit being adapted to:
receive said signal indicative of a reading of said optical storage medium by a reading unit;
maintain a count of a number of readings of said optical storage medium by a reading unit;
determine whether said count of a number of readings of said optical storage medium by a reading unit has reached said threshold value;
receive said signal indicative of a measurement of time elapsed from a certain point in time; and
determine whether said measurement of time elapsed from a certain point in time has reached said threshold value.

22. An information storage device as defined in claim 1, said activation unit including an energy source electrically coupled to said impairment unit, said activation unit being adapted to conditionally activate said impairment unit comprising conditionally supplying energy from said energy source to said impairment unit.

23. An information storage device as defined in claim 22, wherein said energy source includes an electrochemical generator.

24. An information storage device as defined in claim 23, wherein said electrochemical generator comprises at least one zinc manganese dioxide.

25. An information storage device as defined in claim 1, wherein said impairment unit is a first impairment unit, said information storage device comprising:
a second impairment unit coupled to said optical storage medium and capable of being activated electrically, said second impairment unit being operative to impair optical integrity of at least one of said portion of said optical storage medium and an other portion of said optical storage medium when activated;
said activation unit being electrically coupled to said second impairment unit and adapted to conditionally activate said second impairment unit.

26. An information storage device as defined in claim 25, wherein said activation unit is adapted to:
detect a defective operation of said first impairment unit, said second impairment unit, and said activation unit itself;
responsive to detection of a defective operation of a given one of said first impairment unit, said second impairment unit, and said activation unit itself, activate a certain one of said first impairment unit or said second impairment unit that is not said given one of said first impairment unit, said second impairment unit.

27. An information storage device as defined in claim 26, wherein said activation unit is adapted to detect an open electrical connection inside said activation unit, between said activation unit and said first impairment unit, and between said activation unit and said second impairment unit, said activation unit being adapted to detect a defective operation of said first impairment unit, said second impairment unit, and said activation unit itself comprising detecting an open electrical connection inside said activation unit, between said activation unit and said first impairment unit, or between said activation unit and said second impairment unit.

28. An information storage device as defined in claim 1, wherein said impairment unit and said activation unit are embedded in said optical storage medium.

29. An information storage device as defined in claim 1, wherein said optical storage medium is a DVD.

30. An information storage device as defined in claim 1, wherein said optical storage medium is a CD.

31. An information storage device comprising:
an optical storage medium;
impairment means coupled to said optical storage medium and capable of being activated electrically, for impairing optical integrity of a portion of said optical storage medium when activated; and
activation means electrically coupled to said impairment means for conditionally activating said impairment means.

32. A method of manufacturing an information storage device, said method comprising:
providing an optical storage medium;
coupling an impairment unit to the optical storage medium, the impairment unit being capable of being activated electrically and operative to impair optical integrity of a portion of the optical storage medium when activated; and
electrically coupling an activation unit to the impairment unit, the activation unit being adapted to conditionally activate the impairment unit.

33. A method of providing an information storage device, said method comprising:
a) providing an information storage device including:
an optical storage medium;
an impairment unit coupled to the optical storage medium and capable of being activated electrically, the impairment unit being operative to impair optical integrity of a portion of the optical storage medium when activated; and
a programmable activation unit electrically coupled to the impairment unit and adapted to activate the impairment unit upon satisfaction of a condition;
b) receiving an indication of a limit on usage of the optical storage medium;
c) setting the condition of the activation unit to reflect the limit on usage of the optical storage medium.

34. A method as defined in claim 33, wherein the limit on usage of the optical storage medium is specified by a certain number of readings of the optical storage medium by a reading unit.

35. A method as defined in claim 34, wherein the activation unit is adapted to count a number of readings of the optical storage medium by a reading unit, said setting the condition of the activation unit to reflect the limit on usage of the optical storage medium comprising:
setting the condition of the activation unit such that the condition is satisfied when a count of a number of readings of the optical storage medium by a reading unit has reached the certain number of readings of the optical storage medium by a reading unit.

36. A method as defined in claim 33, wherein the limit on usage of the optical storage medium is specified by a certain amount of time elapsed from a certain point in time.

37. A method as defined in claim 36, wherein the activation unit is adapted to measure time elapsed from a certain point in time, said setting the condition of the activation unit to reflect the limit on usage of the optical storage medium comprising:
setting the condition of the activation unit such that the condition is satisfied when a measurement of time from a certain point in time has reached the certain amount of time elapsed from a certain point in time.

38. A method as defined in claim 33, wherein the limit on usage of the optical storage medium is specified by at least one of:
a certain number of readings of the optical storage medium by a reading unit; or
a certain amount of time elapsed from a certain point in time.

39. A method as defined in claim 34, wherein the activation unit is adapted to:
count a number of readings of the optical storage medium by a reading unit; and
measure time elapsed from a certain point in time;
said setting the condition of the activation unit to reflect the limit on usage of the optical storage medium comprising:
setting the condition of the activation unit such that the condition is satisfied when at least one of:
a count of a number of readings of the optical storage medium by a reading unit has reached the certain number of readings of the optical storage medium by a reading unit; or
a measurement of time from a certain point in time has reached the certain amount of time elapsed from a certain point in time.

40. A method as defined in claim 33, wherein the optical storage medium stores information representing an audio/video content.

41. A method as defined in claim 33, wherein the optical storage medium stores information representing software.

42. A method as defined in claim 33, wherein the optical storage medium is a DVD.

43. A method as defined in claim 33, wherein the optical storage medium is a CD.
